(19) United States
(12) Patent Application Publication
(10) Pub. No.: US 2010/0008695 A1
(43) Pub. Date: Jan. 14, 2010

(54) IMAGE FORMING APPARATUS

(76) Inventors: Satoshi OKANO, Kanagawa (JP); Tomoyasu HIRASAWA, Kanagawa (JP); Hitoshi NAKAMURA, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/497,182

(22) Filed: Jul. 2, 2009

(30) Foreign Application Priority Data
Jul. 10, 2008 (JP) 2008-180377

(51) Int. Cl. G03G 21/20

(52) U.S. Cl. 399/94

(57) ABSTRACT

An image forming apparatus having a liquid-cooled cooling system prevents problems caused by a potential leakage of coolant used in the liquid-cooled cooling system. The liquid-cooled cooling system cools a heat-generating image forming portion using the coolant, which is circulated by a pump through a circulating path. The cooling system includes a heat-receiving member disposed in thermal contact with the image forming portion to absorb heat generated by the image forming portion. The heat-receiving member is connected with the circulating path via a joint. The joint is disposed within an enclosed space between the image forming portion and an electrical component drive portion for driving or controlling the image forming portion, so that the image forming portion and the electrical component drive portion can be protected from the coolant in the event of coolant leakage via the joint.

### BACKGROUND OF THE INVENTION

1. Field of the Invention

The present invention generally relates to image forming apparatuses for forming an image based on electrophotography, such as copy machines and printers. In particular, the invention relates to an image forming apparatus equipped with a liquid-cooled cooling system for cooling heat-generating units of the apparatus, such as a developing unit.

2. Description of the Related Art

Electrophotographic image forming apparatuses, such as copy machines, printers, facsimiles, and multifunction peripherals, contain various units that generate heat during an image forming operation, such as a write unit and a developing unit. These units may be cooled by an air-cooled system using a cooling fan. However, the amount of heat generated by these units in an image forming apparatuses has increased as a result of increases in image formation processing speed. Particularly in the developing unit, increases in the speed at which a developing process is performed have led to increases in the amount of frictional heat produced by the stirring of a toner and a carrier for imparting an electric charge to the toner, where the temperature of the toner increases as high as its softening point. Sine the resultant molten toner may coagulate and cause a developing defect, the toner needs to be maintained at temperatures below the softening point temperature of the toner.

Recently, an image forming apparatus having a liquid-cooled cooling system has been proposed (see Japanese Laid-Open Patent Application No. 2007-24985, for example). In this apparatus, in order to achieve enhanced cooling performance, a liquid coolant is circulated between a heat-receiving member disposed adjoining an increased-temperature area, such as the developing unit, and a radiator (heat exchanger). Such an image forming apparatus based on electrophotography and equipped with a liquid-cooled system generally assumes installation in offices and the like.

As a result of the increases made in image formation processing speed, the electrophotographic image forming apparatuses have come to be increasingly employed for applications where a recording medium such as sheets of paper is continuously fed for a long period of time (such as for days) for printing purposes, for example.

Such an electrophotographic image forming apparatus may be referred to as a “high-speed machine” which is typically capable of performing an image forming process at the rate of 100 to 120 A4-sized sheets per minute. Such high-speed machines may also be equipped with the aforementioned type of a liquid-cooled cooling system in order to prevent developing defects caused by temperature increases associated with the increase in image formation processing speed, particularly the increase in toner temperature in the developing unit.

When the aforementioned image forming apparatus equipped with the liquid-cooled cooling system is operated continuously for a long time, the coolant may leak via a joint between a pipe (such as a coolant inlet- or outlet-side pipe attached to the heat-receiving member adjoining the developing unit) and a tube for forming a circulating path, due to the aging of the image forming apparatus or the like. It is desirable to prevent such leakage from adversely affecting the various image forming units responsible for the image forming operation and electrical component drive units and the like for driving and controlling the image forming units, so that the image forming process can be performed safely and reliably.

### SUMMARY OF THE INVENTION

It is a general object of the present invention to provide a novel and useful image forming apparatus in which one or more of the aforementioned problems are eliminated.

A more specific object of the present invention is to provide an image forming apparatus in which an image forming portion for performing an image forming operation and an electrical component drive portion and the like for driving or controlling the image forming portion are protected from coolant leakage via a joint between a pipe (such as a coolant inlet- or outlet-side pipe) attached to a heat-receiving member and a tube for forming a circulating path, so that an image forming process can be performed safely and reliably.

According to one aspect of the present invention, an image forming apparatus includes a liquid-cooled cooling system for cooling an image forming portion whose temperature is increased by an image forming operation, using a coolant. The liquid-cooled cooling system includes a heat-receiving member disposed in thermal contact with the image forming portion and having a flow path through which the coolant flows; an inlet-side pipe attached to a coolant inlet side of the flow path in the heat-receiving member; an outlet-side pipe attached to a coolant outlet side of the flow path in the heat-receiving member; a tube member connected between the inlet-side pipe and the outlet-side pipe for forming a circulating path for circulating the coolant through the flow path in the heat-receiving member; a pump disposed at a point along the tube member for circulating the coolant; and a radiating unit disposed at another point along the tube member and configured to radiate heat absorbed by the coolant from the image forming portion via the heat-receiving member.

The inlet-side pipe and the outlet-side pipe attached to the heat-receiving member are connected to the tube member via a joint. The joint is disposed within a space provided between the image forming portion and an electrical component drive portion for driving or controlling the image forming portion.

### BRIEF DESCRIPTION OF THE DRAWINGS

Other objects, features and advantages of the present invention will become apparent upon consideration of the specification and the appendant drawings, in which:

FIG. 1 shows an image forming apparatus having a cooling system according to Embodiment 1 of the present invention;

FIG. 2 shows a side view of a joint portion near a heat-receiving member of the liquid-cooled cooling system according to Embodiment 1;

FIG. 3 shows a schematic plan view of the joint portion near the heat-receiving member of the liquid-cooled cooling system according to Embodiment 1;

FIG. 4 shows a schematic side view of the joint portion near the heat-receiving member of a cooling system according to Embodiment 2;

FIG. 5 shows a schematic side view of the joint portion near the heat-receiving member of a liquid-cooled cooling system according to Embodiment 3;

FIG. 6 shows a schematic side view of the joint portion near the heat-receiving member of a liquid-cooled cooling system according to Embodiment 4;

FIG. 7 shows a schematic side view of the joint portion near the heat-receiving member of a cooling system according to Embodiment 5;

FIG. 8 shows a schematic side view of the joint portion near the heat-receiving member of a cooling system according to Embodiment 6;

FIG. 9 shows a schematic side view of the joint portion near the heat-receiving member of a cooling system according to Embodiment 7;

FIG. 10 shows a schematic side view of the joint portion near the heat-receiving member of a cooling system according to Embodiment 8; and

FIG. 11 shows an image forming apparatus according to Embodiment 9 having a liquid-cooled cooling system.

### DETAILED DESCRIPTION OF THE PREFERRED EMBODIMENTS

In the following, embodiments of the present invention are described with reference to the drawings.

### Embodiment 1

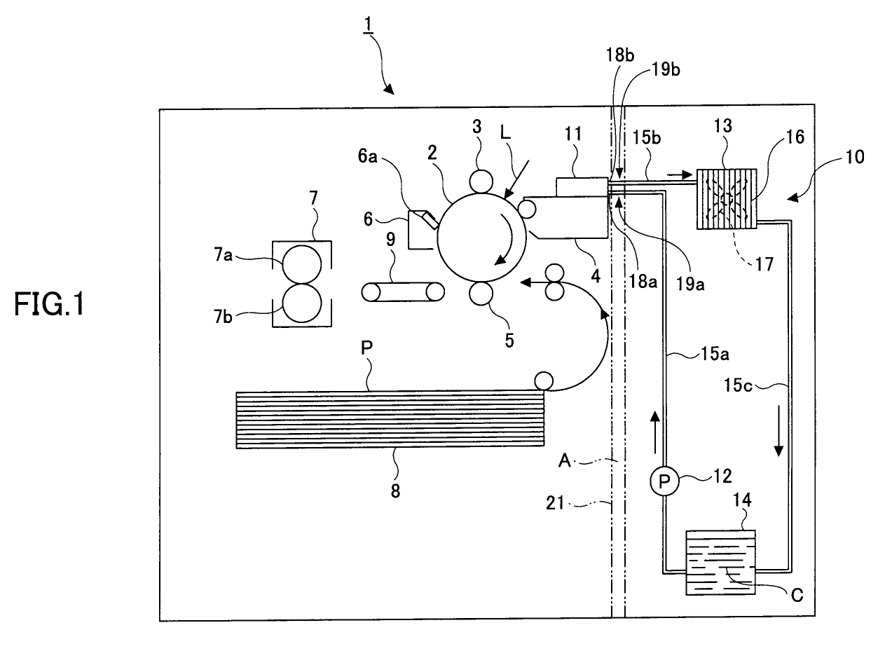

FIG. 1 shows an image forming apparatus 1 based on electrophotography equipped with a liquid-cooled cooling system according to Embodiment 1 of the present invention. The image forming apparatus 1 is a high-speed machine capable of performing an image forming process (such as printing) at the rate of 100 to 120 A4-sized sheets per minute, for example, where a recording medium such as sheets of paper may be fed continuously for a long time (such as for days).

As shown in FIG. 1, the image forming apparatus (which may be a printer) 1, which is configured to output a black-and-white image, includes a photosensitive drum 2 around which a charging roller 3, a developing unit 4, a transfer roller 5, and a cleaning unit 6 are disposed. A fusing unit 7 is disposed downstream of the transfer roller 5 in a direction of transport of a recording sheet P. The developing unit 4 is in thermal contact with a heat-receiving member 11 of a liquid-cooled cooling system 10. The details of the liquid-cooled cooling system 10 are described later.

During an image forming operation, the surface of the photosensitive drum 2 as it is rotated at a predetermined process speed is uniformly charged by the charging roller 3. The charged surface of the photosensitive drum 2 is exposed to light L in accordance with desired image information by an exposing unit (not shown), whereby a static latent image is formed on the photosensitive drum 2. The latent image is then developed by the developing unit 4 using a toner (developing agent), thereby forming a toner image on the photosensitive drum 2 in accordance with the image information.

The recording sheet P as a recording medium is fed from a cassette 8 at a predetermined timing and transported along a transport path (not shown) to a transfer area between the photosensitive drum 2 and the transfer roller 5, where the toner image carried on the photosensitive drum 2 is transferred to the recording sheet P by the transfer roller 5 to which a transfer bias is applied. The recording sheet P with the toner image transferred thereon is further transported by a transfer belt 9 to the fusing unit 7, where the black-and-white toner image on the recording sheet P is heated and pressed in a fusing nip between a fusing roller 7a and a pressure roller 7b of the fusing unit 7, thereby fusing the toner image on the recording sheet P. The recording sheet P with the black-and-white toner image fused thereon is then ejected to the outside by ejection rollers (not shown). The toner that may remain on the photosensitive drum 2 after the transfer process is removed by a cleaning blade 6a of the cleaning unit 6 and collected.

As the image forming apparatus 1 is operated for a long time continuously for an image forming process at high speed as mentioned above, the amount of heat generated within the image forming apparatus 1 increases. Particularly, during the developing step involving the developing unit 4, the temperature of the toner increases due to the friction heat or the like produced as the toner and a carrier are stirred to impart an electric charge to the toner. Thus, the image forming apparatus 1 according to the present embodiment is equipped with the liquid-cooled cooling system 10 for cooling the developing unit 4 so as to prevent the increase of toner temperature above a softening point temperature of the toner. Hereafter, the liquid-cooled cooling system 10 is described.

As shown in FIG. 1, the liquid-cooled cooling system 10 includes the heat-receiving member 11 disposed in thermal contact with the developing unit 4; a pump 12 for circulating a coolant C, a heat exchanger (radiator) 13 for dissipating heat from the coolant with increased temperature; a tank 14 in which the coolant C is stored; a first tube 15a connected between the tank 14 and the heat-receiving member 11; a second tube 15b connected between the heat-receiving member 11 and the heat exchanger 13; and a third tube 15c connected between the heat exchanger 13 and the tank 14. In the liquid-cooled cooling system 10, the coolant C is circulated by the pump 12 coupled in the first tube 15a through the first tube 15a, the heat-receiving member 11, the second tube 15b, the heat exchanger 13, the third tube 15c, and the tank 8.

The heat-receiving member 11 may be made of aluminum so that the heat received from the adjoining developing unit 4 can be quickly and efficiently transferred to the coolant. The heat-receiving member 11 may contain a flow passage (not shown) which may be meandering. The heat exchanger 13 also contains a flow passage (not shown) which may be meandering, with plural radiating fins 16 provided on the surface thereof. The heat exchanger 13 includes a fan 17 for effective radiation of heat. The heat exchanger 13 is disposed near an exhaust outlet (not shown) formed on a side (or back) surface of the image forming apparatus 1. The tank 14 in which the coolant C is stored is disposed at near the bottom of the image forming apparatus 1.

The first tube 15a, the second tube 15b, and the third tube 15c may be made of a flexible composite material of butyl rubber and EPDM (ethylene-propylene rubber). The coolant that is circulated may include water or an antifreeze containing an anticorrosive. The antifreeze may include an aqueous solution of ethylene glycol, or an aqueous solution of propylene glycol which has less toxicity and lower melting point.

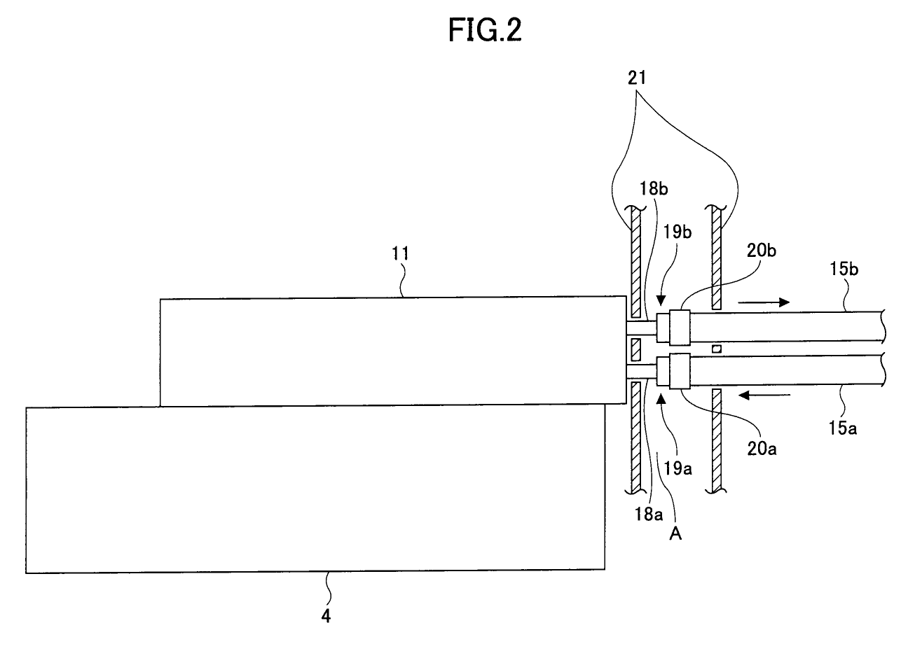

Referring to FIG. 2, an inlet-side pipe 18a and an outlet-side pipe 18b protrude from one side of the heat-receiving member 11. The inlet-side pipe 18a is attached on a coolant inlet side of the internal flow path (not shown). The outlet-side pipe 18b is attached on a coolant outlet side of the internal flow path. The inlet-side pipe 18a is fitted into and connected with one end of the first tube 15a via a joint portion 19a. The outlet-side pipe 18b is fitted into and connected with one end of the second tube 15b via another joint portion 19b. Outer circumferential surfaces of the joint portions 19a and 19b are fastened with fastening members 20a and 20b, respectively.

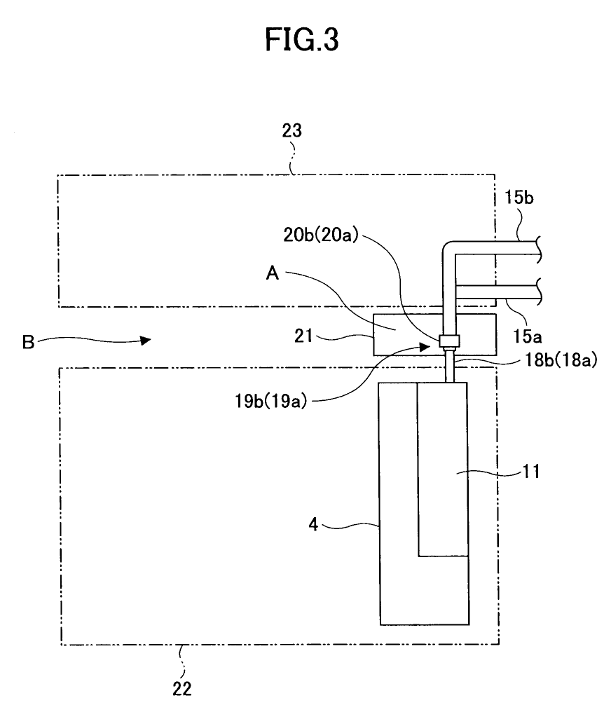

The joint portions 19a and 19b are disposed horizontally (left-right in FIG. 2) within a space A defined by shielding members 21. The shielding members 21 are disposed in such a way as to enclose the joint portions 19a and 19b vertically in the image forming apparatus 1. As shown in FIG. 3, the shielding members 21 are disposed in a region B between an image forming portion 22 (including the photosensitive drum 2, the charging roller 3, the developing unit 4, the transfer roller 5, and the cleaning unit 6) and an electrical component drive portion 23 (including a control unit, a drive unit, and a power supply unit, which are not shown) for driving or controlling the image forming portion 22. Thus, the joint portions 19a and 19b are separated from both the image forming portion 22 and the electrical component drive portion 23.

### (Cooling By Cooling System During an Image Forming Operation)

During the aforementioned image forming operation, the pump 12 is activated in response to a signal from the control unit (not shown) so that the coolant C can be sucked from the tank 14 toward the pump 12, whereby the coolant C flows through the flow path (not shown) within the heat-receiving member 11 through the first tube 15a and the inlet-side pipe 18a.

The heat generated by the developing unit 4 during the developing step is absorbed by the coolant as it flows through the flow path within the heat-receiving member 11, thus cooling the developing unit 4. The coolant with the increased temperature is then sent via the outlet-side pipe 18b and the second tube 15b to the heat exchanger 13, where the heat stored in the coolant is dissipated to the outside via the radiating fins 16. At the same time, the fan 17 is activated for more effective heat dissipation. The coolant from which the heat has been thus dissipated by the heat exchanger 13 is then returned via the third tube 15c to the tank 14 and then re-circulated in the similar manner for cooling the developing unit 4 again.

An experiment was conducted to evaluate the cooling effect of the liquid-cooled cooling system 10 on the developing unit 4. The experiment involved an image forming operation in which a recording medium was fed continuously for several hours in a constant temperature/humidity environment, where the temperature of the developing unit 4 was measured as the developing unit 4 was cooled by the liquid-cooled cooling system 10. The result showed that the temperature of the developing unit 4 was maintained at approximately 48° C., which was lower than the softening point temperature (about 50° C.) of the toner used, with no recognizable decrease in image quality due to a development defect.

Thus, in the image forming apparatus 1 according to the present embodiment, the coolant flows through the flow path (not shown) within the heat-receiving member 11 adjoining the developing unit 4 during the image forming operation. The coolant carries the heat emitted by the developing unit 4 to the outside of the image forming apparatus 1 via the heat exchanger 13, thereby effectively cooling the developing unit 4. Thus, when the image forming apparatus 1 is operated for a long time (such as for days) continuously at the high rate of 100 to 120 A4-sized sheets per minute, for example, increases in the temperature of toner in the developing unit 4 which causes a development defect can be prevented.

Further, in the image forming apparatus 1, the joint portions 19a and 19b, at which the inlet-side pipes 18a and 18b on the side of the heat-receiving member 11 are connected to the first tube 15a and the second tube 15b, respectively, are enclosed by the shielding members 21 within the space A. Thus, the joint portions 19a and 19b are separated from both the image forming portion 22 and the electrical component drive portion 23.

Thus, should leakage occur via the joint portion 19a or 19b due to the aging of the apparatus, for example, the leaked coolant can be prevented from contacting either the image forming portion 22 or the electrical component drive portion 23. In this way, improved safety against coolant leakage can be achieved, so that the image forming process can be continued without interruptions.

### Embodiment 2

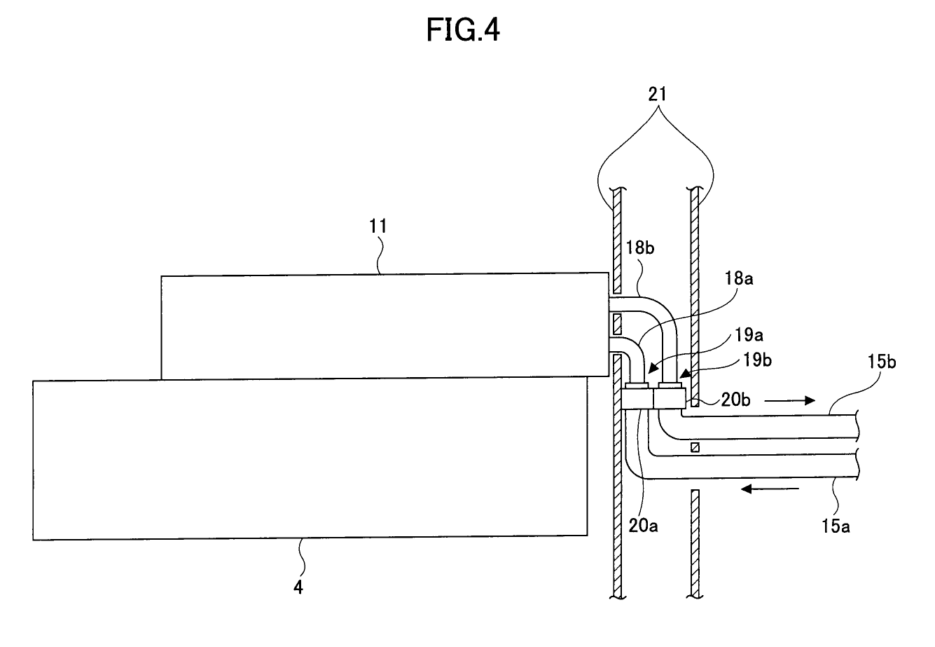

In accordance with Embodiment 2, as shown in FIG. 4, the inlet-side pipes 18a and 18b on the side of the heat-receiving member 11 are bent substantially 90° downward at intermediate portions thereof, so that the joint portions 19a and 19b are vertically disposed in the space A enclosed by the shielding members 21, as opposed to Embodiment 1 in which the joint portions 19a and 19b are disposed horizontally. Embodiment 2 is similar to Embodiment 1 as shown in FIGS. 1 through 3 in other respects, and thus the description of the similar elements or functions is omitted.

### Embodiment 3

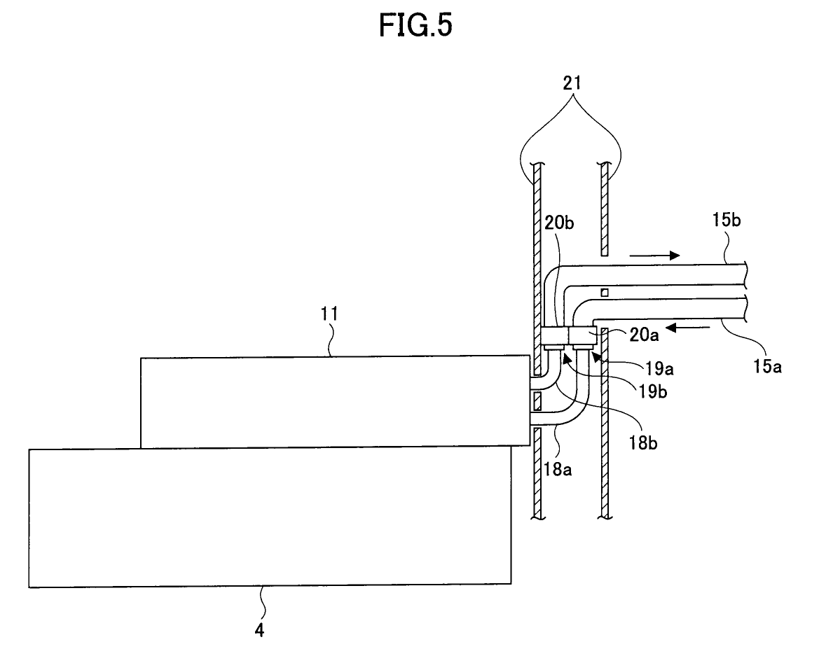

In accordance with Embodiment 3, as shown in FIG. 5, the inlet-side pipes 18a and 18b on the side of the heat-receiving member 11 are bent upward by approximately 90° at intermediate portions thereof, so that the joint portions 19a and 19b are vertically disposed in the space A enclosed by the shielding members 21. Embodiment 3 is similar to Embodiment 1 as shown in FIGS. 1 through 3 in other respects, and therefore the description of the similar elements or functions is omitted. In this embodiment, too, the image forming portion 22 and the electrical component drive portion 23 can be prevented from being immersed in the coolant should it leak via the joint portion 19a or 19b due to the aging of the apparatus, for example, as in Embodiment 1.

### Embodiment 4

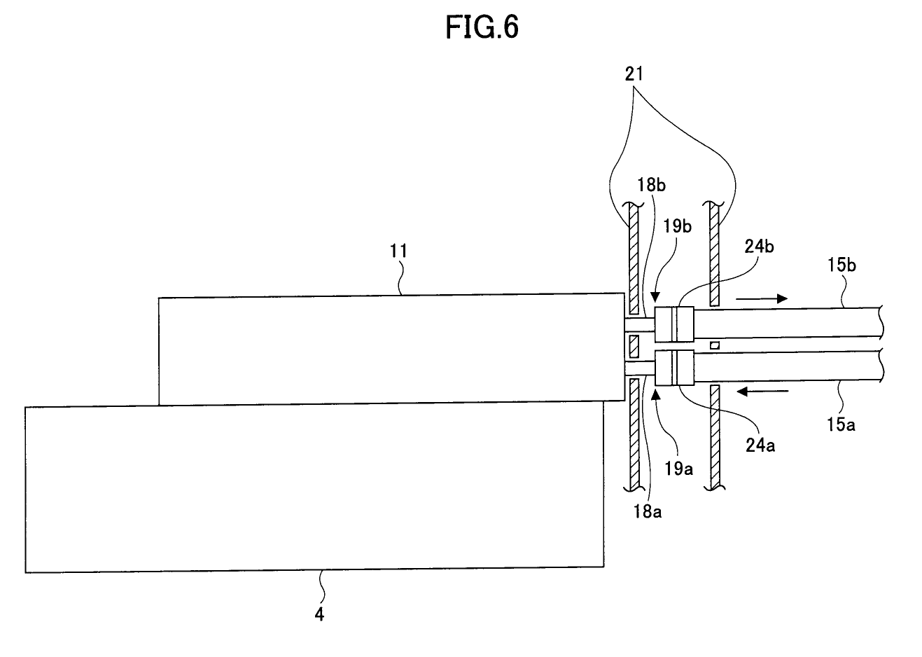

In accordance with Embodiment 4, as shown in FIG. 6, the inlet-side pipes 18a and 18b are connected with the first tube 15a and the second tube 15b, respectively, via universal joints 24a and 24b that are detachable. Embodiment 4 is similar to Embodiment 1 as shown in FIGS. 1 through 3 in other respects, and the description of the similar or corresponding elements or functions is omitted.

Because the universal joints 24a and 24b can be easily attached and detached, the maintenance of the developing unit 4 and the heat-receiving member 11, for example, is facilitated, in addition to the advantageous effects obtained by Embodiment 1.

### Embodiment 5

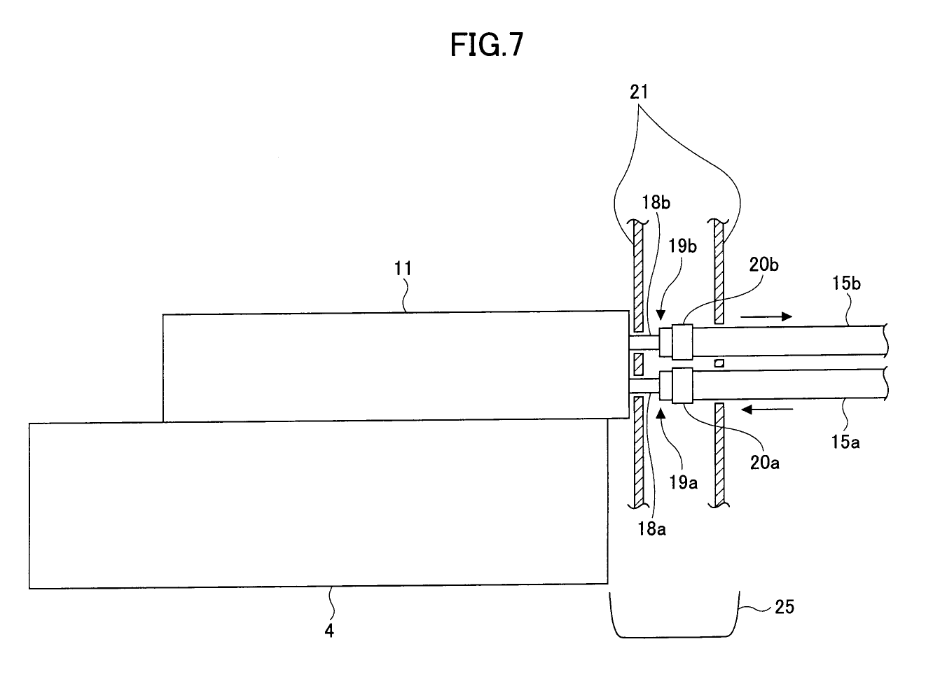

In accordance with Embodiment 5, as shown in FIG. 7, a pan 25 is disposed below the shielding members 21. The present embodiment is similar to Embodiment 1 shown in FIGS. 1 through 3 in other respects, and the description of the similar or corresponding elements or functions is omitted.

The pan 25 disposed below the shielding members 21 can collect the coolant should its leakage occur via the joint portion 19a or 19b due to the aging or the like of the apparatus. Thus, the image forming portion 22 and the electrical component drive portion 23 can be reliably prevented from being immersed with the leaked coolant.

### Embodiment 6

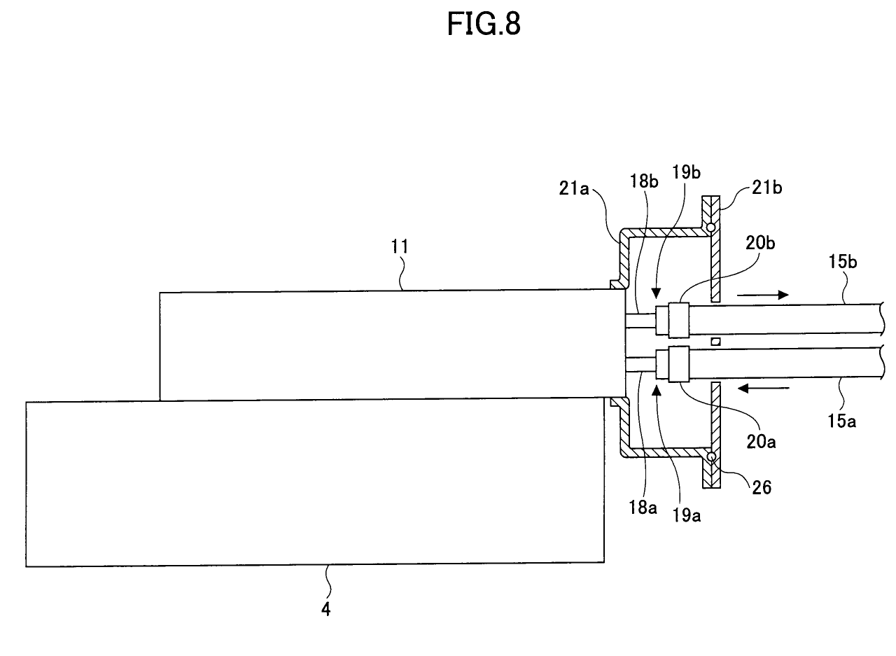

In accordance with Embodiment 6, as shown in FIG. 8, the joint portions 19a and 19b are enclosed by the shielding members 21a and 21b in an airtight manner. The shielding members 21a and 21b are sealed with an O ring 26. The present embodiment is similar to Embodiment 1 shown in FIGS. 1 through 3 in other respects, and the description of the similar or corresponding elements or functions are omitted.

In accordance with Embodiment 6, any coolant that may have leaked via the joint portion 19a or 19b due to the aging or the like of the apparatus can be contained within the shielding members 21a and 21b in an airtight manner. Thus, the image forming portion 22 and the electrical component drive portion 23 can be reliably prevented from being immersed in the leaked coolant.

### Embodiment 7

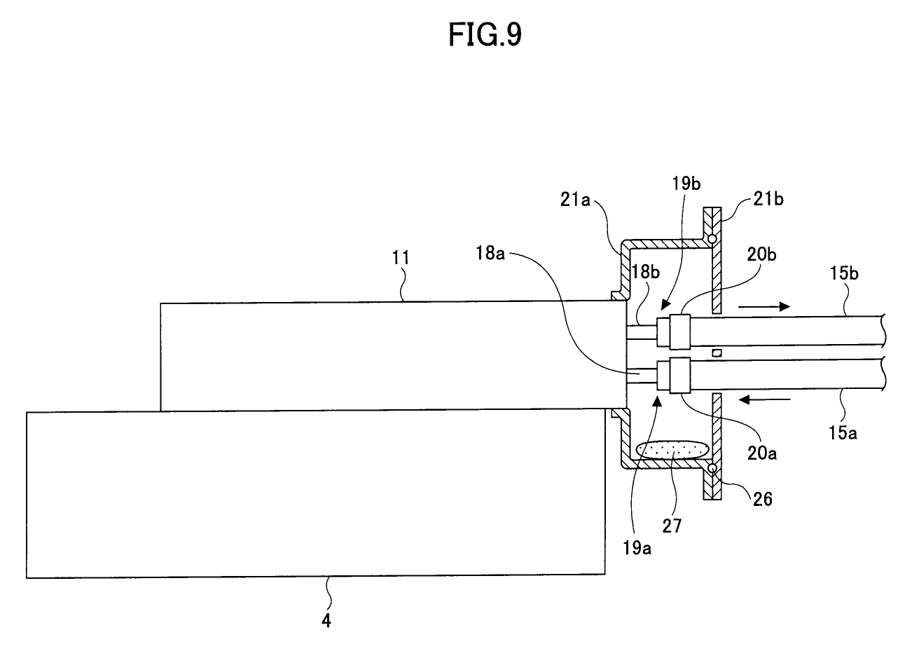

In accordance with Embodiment 7, as shown in FIG. 9, the joint portions 19a and 19b are enclosed by the shielding members 21a and 21b in an airtight manner, where a moisture absorbent 27 is disposed at a lower portion of the space within the shielding members 21a and 21b. The other features of the present embodiment is similar to those of Embodiment 6 described with reference to FIG. 8, and the description of the similar or corresponding elements or functions is omitted.

In accordance with the present embodiment, any coolant that may have leaked via the joint portion 19a or 19b due to the aging or the like can be absorbed by the moisture absorbent 27 within the shielding members 21a and 21b. Thus, the image forming portion 22 and the electrical component drive portion 23 can be reliably prevented from being immersed in the leaked coolant.

### Embodiment 8

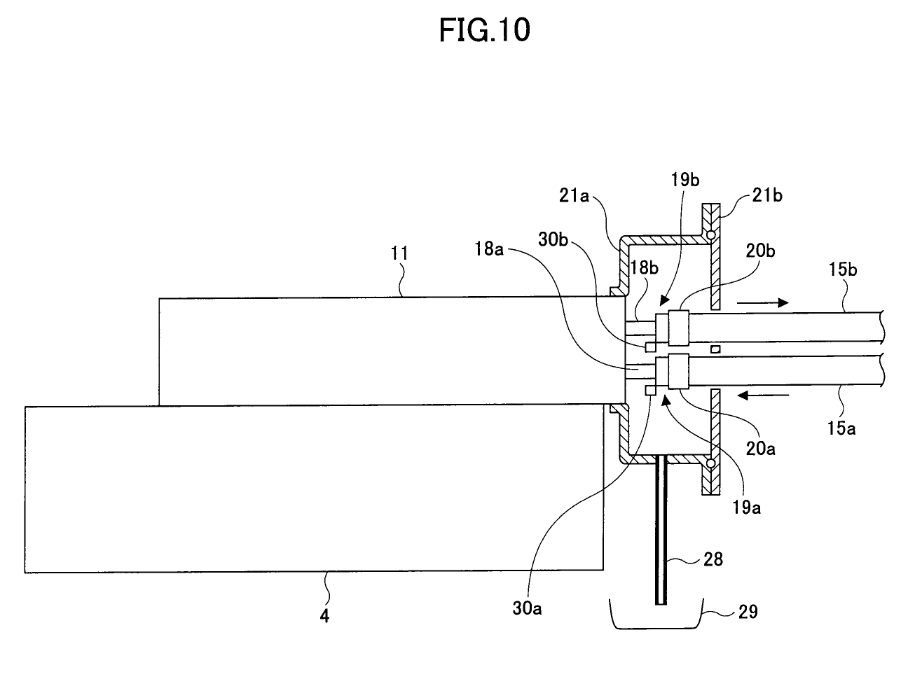

In accordance with Embodiment 8, as shown in FIG. 10, the joint portions 19a and 19b are enclosed by the shielding members 21a and 21b in an airtight manner, where a drainage pipe 28 is installed at the bottom of the shielding member 21a, and the pan 29 is disposed below the drainage pipe 28. Further, leak detection sensors 30a and 30b are provided near the joint portions 19a and 19b, respectively, for detecting a leak. The other features of the present embodiment are similar to those of Embodiment 6 described with reference to FIG. 8, and the description of the similar or corresponding elements or functions is omitted.

In accordance with the present embodiment, any coolant that may have leaked via the joint portion 19a or 19b due to the aging or the like of the apparatus can be collected by the pan 29 via the drainage pipe 28. Thus, the image forming portion 22 and the electrical component drive portion 23 can be reliably prevented from being immersed in the leaked coolant. Preferably, the drainage pipe 28 may be extended so that the pan 29 can be disposed at a desired location.

Further, the leak detection sensors 30a and 30b provided near the joint portions 19a and 19b enable a quick detection of leakage at the joint portion 19a or 19b, so that the leak can be quickly dealt with. The leak detection sensors 30a and 30b may be installed near the joint portions 19a and 19b in any of the foregoing Embodiments 1 through 7.

### Embodiment 9

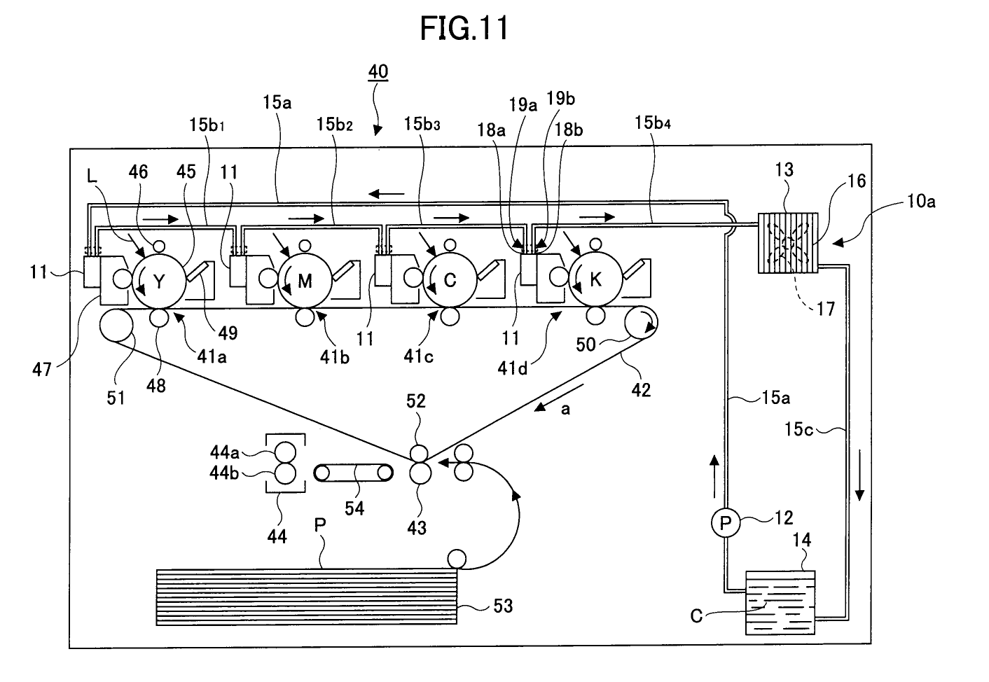

FIG. 11 shows an image forming apparatus 40 according to Embodiment 9 including a liquid-cooled cooling system according to an embodiment of the present invention. The image forming apparatus 40 is a tandem-type color image forming apparatus based on electrophotography, which may include a color copy machine or a color printer. The image forming apparatus 40 is a high-speed machine that may be used for performing an image forming process (such as a printing process) continuously over a long period (such as for days), where a recording medium such as sheets of paper may be continuously fed for printing, for example, at the rate of 100 to 120 A4-sized sheets per minute.

As shown in FIG. 11, the image forming apparatus 40 according to the present embodiment includes four image forming portions 41a, 41b, 41c, and 41d that are disposed at regular intervals. Toner images of the individual colors yellow (Y), magenta (M), cyan (C), and black (K) formed in the respective image forming portions 41a, 41b, 41c, and 41d are superposed upon one another to obtain a full-color toner image that is transferred (primary transfer) onto an endless intermediate transfer belt 42. The full-color toner image on the intermediate transfer belt 42 is then transferred (secondary transfer) onto a recording medium P such as a sheet of paper by a secondary transfer roller 43. The thus transferred full-color toner image is fused on the surface of the recording medium P by a fusing unit 44.

Each of the image forming portions 41a, 41b, 41c, and 41d includes a photosensitive drum 45, a charging roller 46, a developing unit 47, a primary transfer roller 48, and a cleaning unit (cleaning blade) 49.(Reference numerals for these members are omitted with respect to the image forming portions 41b, 41c, and 41d.) The developing unit 47 of each of the image forming portions 41a, 41b, 41c, and 41d contains a toner of the respective color Y, M, C, or K as a developing agent. Each developing unit 47 is disposed adjoining a respective heat-receiving member 11 of a liquid-cooled cooling system 10a, in the same manner as in Embodiment 1.

The basic structure of the liquid-cooled cooling system 10a is similar to Embodiment 1 described with reference to FIG. 1. Namely, a pump 12 coupled in the first tube 15a is activated to cause a coolant to circulate through the first tube 15a, the individual heat-receiving members 11, second tubes 15b1, 15b2, 15b3, and 15b4, a heat exchanger 13, a third tube 15c, and a tank 8. The second tubes 15b1, 15b2, and 15b3 are connected between the individual heat-receiving members 11 disposed adjoining the developing units 47 of the image forming portions 41a, 41b, and 41c. The second tube 15b4 is connected between the heat-receiving member 11 adjoining the developing unit 47 of the image forming portion 41d and the heat exchanger 13.

The endless intermediate transfer belt 42 is extended around a drive roller 50, a driven roller 51, and an opposite roller 52, and is moved by the drive roller 50 in the direction of an arrow A. The intermediate transfer belt 42 travels through a nipping portion between the photosensitive drum 45 and the primary transfer roller 48 of each of the image forming portions 41a, 41b, 41c, and 41d. The secondary transfer roller 43 abuts on an outer circumferential surface of the intermediate transfer belt 42 opposite the opposite roller 52.

During an image forming operation by the image forming apparatus 40, a voltage is applied to the charging roller 46 of each of the image forming portions 41a, 41b, 41c, and 41d in order to uniformly charge the surface of each photosensitive drum 45 as it is rotated in the direction of the arrow at a predetermined process speed. The surface of the photosensitive drum 45 is then exposed to laser light L emitted by an exposing unit (not shown), whereby a static latent image corresponding to certain image information is formed.

The static latent image formed on the surface of each photosensitive drum 45 is then developed (visualized) by attaching the toner of the corresponding color (yellow, magenta, cyan, or black) to the latent image by the individual developing unit 47. As a result, a toner image of the respective color is formed on the surface of the respective photosensitive drum 45. These toner images of the various colors are then transferred by the respective primary transfer rollers 48, to which a transfer bias is applied, onto the intermediate transfer belt 42 one color upon another, as the intermediate transfer belt 42 is moved by the drive roller 50. Thus, a full-color toner image is formed on the intermediate transfer belt 42. The toner that may remain on the surface of each photosensitive drum 45 after the transfer step is removed by a cleaning unit (cleaning blade) 49 and collected.

The full-color toner image carried on the intermediate transfer belt 42 is thereafter transferred (secondary transfer) by the secondary transfer roller 43, to which a transfer bias is applied, onto the recording medium P at once, as the recording medium P is fed at a predetermined timing from the cassette 53 and transported via a transport path to the transfer area between the intermediate transfer belt 42 and the secondary transfer roller 43. The recording medium P with the toner image transferred thereon is transported by the transfer belt 54 to the fusing unit 44. At the fusing unit 44, the recording medium P is heated and pressed between the fusing roller 44a and the pressure roller 44b, whereby the full-color toner image is fused on the recording medium P. The recording medium P with the full-color toner image fused thereon is then ejected to the outside by ejection rollers (not shown).

As mentioned above, the image forming apparatus 40 is a high-speed machine capable of performing an image forming process (such as printing) at the rate of 100 to 120 A4-sized sheets per minute, where the recording medium P, such as sheets of paper, may be fed continuously for a long time (such as for days). Consequently, much heat is generated within the image forming apparatus 40. Particularly in the image forming portions 41a, 41b, 41c, and 41d, the temperature of toner increases during the developing step performed by the developing unit 47 due to the friction heat or the like that is caused when the toner and a carrier are stirred to impart an electric charge to the toner. Thus, the individual developing units 47 are cooled by the liquid-cooled cooling system 10a so that the toner does not exceed its softening point temperature.

### (Cooling Operation By Cooling System During Image Forming Operation)

During the aforementioned image forming operation, the pump 12 is activated based on a signal from a control unit (not shown) to suck the coolant C from the tank 14 toward the pump 12. The coolant C is transported along the first tube 15a and it initially flows through the flow path (not shown) within the heat-receiving member 11 adjoining the developing unit 47 of the image forming portion 41a. The coolant then passes through the second tubes 15b1, 15b2, and 15b3 and flows through the flow paths (not shown) within the respective heat-receiving members 11 adjoining the respective developing units 47 in the image forming portions 41b, 41c, and 41d. Thereafter, the coolant is returned via the second tube 15b4 to the heat exchanger 13, where the heat stored in the coolant is dissipated to the outside via the radiating fins 16. At the same time, the fan 17 may be rotated for more effective heat dissipation. The coolant from which the heat has thus been removed by the heat exchanger 13 is then returned back to the tank 14 via the third tube 15c, and re-circulated in the same manner to cool the individual developing units 47 in the image forming portions 41a, 41b, 41c, and 41d again.

An experiment was conducted to evaluate the cooling effect of the liquid-cooled cooling system 10a on the developing units 47. The experiment involved an image forming operation in which a recording medium was continuously fed in a constant temperature/humidity environment for several hours, where the temperature of each of the developing unit 47 was measured when the developing unit 47 was cooled by the liquid-cooled cooling system 10. The result showed that the temperature of the developing unit 4 remained at about 43° C., which was lower than the softening point temperature (about 45° C.) of the toner of each color, exhibiting no recognizable decrease in image quality due to a development defect.

In accordance with the present embodiment, in each of the image forming portions 41a, 41b, 41c, and 41d, the joint portions 19a and 19b at which the inlet-side pipe 18a and the outlet-side pipe 18b are connected to the second tubes 15b3 and 15b4, respectively, may be enclosed by shielding members in an airtight manner, as according to Embodiment 8 shown in FIG. 10. Preferably, a drainage pipe may be installed at the bottom of the shielding member, with a pan disposed below the drainage pipe, as according to Embodiment 8 shown in FIG. 10. Preferably, the joint portions 19a and 19b may be provided with any of the structures according to Embodiments 1 through 7, besides the structure according to Embodiment 8 shown in FIG. 10.

While in FIG. 11 the joint portions 19a and 19b are indicated only for the heat-receiving member 11 adjoining the developing unit 47 of the image forming portion 41d, similar joint portions are also provided to the heat-receiving member 11 adjoining the developing unit 47 of each of the other image forming portions 41a, 41b, and 41c.

As in Embodiment 1, the joint portions 19a and 19b of each heat-receiving member 11 are located in a region between the image forming portion (including the photosensitive drum 45, the charging roller 46, the developing unit 47, the transfer roller 48, and the cleaning unit 49) 41a, 41b, 41c, or 41d and the electrical component drive portion (including the control unit, a drive unit, and a power supply unit, which are not shown) for the image forming portion 41a, 41b, 41c, or 41d.

Thus, if coolant leakage occurs at the joint portion 19a or 19b of any of the heat-receiving members 11 adjoining the developing units 47 due to the aging or the like, the leaked coolant can be prevented from immersing the image forming portion 41a, 41b, 41c, or 41d or the electrical component drive portion. As a result, enhanced safety against coolant leakage can be ensured, and an apparatus failure or the like can be prevented in the event of such a coolant leakage, allowing the aforementioned high-speed image forming process to be performed for a long time (such as for days) continuously at the rate of 100 to 120 A4-sized sheets per minute without interruptions.

While in accordance with the foregoing embodiments it has been the developing unit of the image forming apparatus that is cooled by the coolant, the various embodiments of the present invention may be applied for cooling other units subject to increased temperatures, such as the charging unit, the write unit, the transfer unit, and the cleaning unit.

The various embodiments of the present invention may also be applied to various electrophotographic image forming apparatuses other than the high-speed machine described in the foregoing embodiments, such as copy machines and printers that are generally used in offices.

Although this invention has been described in detail with reference to certain embodiments, variations and modifications exist within the scope and spirit of the invention as described and defined in the following claims.

The present application is based on the Japanese Priority Application No. 2008-180377 filed Jul. 10, 2008, the entire contents of which are hereby incorporated by reference.

What is claimed is:

1. An image forming apparatus comprising a liquid-cooled cooling system for cooling an image forming portion whose temperature is increased by an image forming operation, using a coolant,
wherein the liquid-cooled cooling system includes:
a heat-receiving member disposed in thermal contact with the image forming portion and having a flow path through which the coolant flows;
an inlet-side pipe attached to a coolant inlet side of the flow path in the heat-receiving member;
an outlet-side pipe attached to a coolant outlet side of the flow path in the heat-receiving member;
a tube member connected between the inlet-side pipe and the outlet-side pipe for forming a circulating path for circulating the coolant through the flow path in the heat-receiving member;
a pump disposed at a point along the tube member for circulating the coolant; and
a radiating unit disposed at another point along the tube member and configured to radiate heat absorbed by the coolant from the image forming portion via the heat-receiving member,
wherein the inlet-side pipe and the outlet-side pipe attached to the heat-receiving member are connected to the tube member via a joint,
wherein the joint is disposed within a space provided between the image forming portion and an electrical component drive portion for driving or controlling the image forming portion.

2. The image forming apparatus according to claim 1, wherein the joint is enclosed by a shielding member configured to shield the joint portion from the image forming portion and the electrical component drive portion.

3. The image forming apparatus according to claim 1, further comprising a fluid collecting member disposed below the joint.

4. The image forming apparatus according to claim 2, wherein the joint is enclosed by the shielding member in an airtight manner.

5. The image forming apparatus according to claim 4, wherein a moisture absorbent is disposed inside the shielding member.

6. The image forming apparatus according to claim 5, further comprising an exhaust pipe disposed under the shielding member and a fluid collecting member disposed at an end of the exhaust pipe.

7. The image forming apparatus according to claim 1, further comprising a leak detection sensor disposed near the joint.
